(19) United States
(12) Patent Application Publication
(10) Pub. No.: US 2013/0227034 A1
(43) Pub. Date: Aug. 29, 2013

(54) EFFICIENT EMAIL PROCESSING BY INSTANT STATE NOTIFICATION

(71) Applicant: INTERNATIONAL BUSINESS MACHINES CORPORATION, (US)

(72) Inventors: Jian Jiang, Shanghai (CN); Jian Gang Ren, Shanghai (CN); Bei Shu, Shanghai (CN)

(73) Assignee: INTERNATIONAL BUSINESS MACHINES CORPORATION, Armonk, NY (US)

(21) Appl. No.: 13/771,883

(22) Filed: Feb. 20, 2013

(30) Foreign Application Priority Data
Feb. 29, 2012 (CN) 201210049465.7

(51) Int. Cl. H04L 12/58

(52) U.S. Cl. CPC H04L 51/00
USPC 709/206

(57) ABSTRACT

Processing an email includes receiving, using a processor, operation status information of an operation on an email by a user. The operation status information includes user identification information of the user, email identification information of the email, and the current operation status on the email by the user. The operation status information of the operation on the email by the user is stored. Using the processor, the stored operation status information is transmitted to other users associated with the email.

### CROSS-REFERENCE TO RELATED APPLICATIONS

This application claims the benefit of China Application Number 201210049465.7 filed on Feb. 29, 2012, which is fully incorporated herein by reference.

### BACKGROUND

Email is a major communication tool in the current commercial environment and personal social networks. Particularly in the commercial domain, people are receiving more and more emails, and have to process the emails in a required time frame.

However, much of the time people spend reading and writing emails often is in fact unnecessary. For example, when a person has just replied to an email, he/she may find that the sender of the original email has sent an email again to indicate that the request in the previous email has been cancelled. He/she has had no need to reply to that email, but since he/she has just replied to the email, the sender needs to re-read the replied email and may need to send another email to indicate again that there has been no need to send his previous reply email.

Still for example, when a person has just replied to an email, some other people on the To list have also made similar reply. Therefore, he/she has had no need to reply to that email at first, and the sender will get many similar replies and spend much greater time to read these replies.

Still for example, when a person has just replied to an email, some other people on the To list have also given replies in the meantime, and the sender decides to modify his original request according to one of the replies. Therefore, the repliers need to reply to the modified email request again.

Also the following situation may exist: when a person has just read a long email, the sender sends another email to indicate that the information in the previous email is no longer valid, and thus he/she has had no need to read the first email.

For daily work, the above-mentioned situations are very common. Moreover, the more people that are involved in an email, the higher the probability repeated replies will appear, which also need to be clarified repeatedly.

Current email applications, e.g., LOTUS NOTES, OUTLOOK or network-based email service platforms such as GMAIL, YAHOO!, SINA, HOTMAIL, etc., have designed some features to improve the effectiveness of cooperation, but those all focus on reducing the time for reading emails.

For example, some email applications provide a function to classify emails by threads, so as to help people to find the latest response for each email conversation thread.

Some email applications are integrated with an IM tool, and may help a receiver to know the online status of all the people involved in the email. The receiver may select whether to reply by email or to have an online chat. However, one cannot tell the online status of an email group, and the online status is not directly associated with whether the person is reading or replying to the email.

Therefore, a solution to reduce unnecessary time that people spend on emails is needed.

### BRIEF SUMMARY

A method of processing an email includes receiving, using a processor, operation status information of an operation on an email by a user. The operation status information includes user identification information of the user, email identification information of the email, and the current operation status on the email by the user. The method further includes storing the operation status information of the operation on the email by the user and transmitting, using the processor, the stored operation status information to other users associated with the email.

A system for processing an email includes a processor programmed to initiate executable operations. The executable operations include receiving operation status information of an operation on an email by a user. The operation status information includes user identification information of the user, email identification information of the email, and the current operation status on the email by the user. The executable operations further include storing the operation status information of the operation on the email by the user and transmitting the stored operation status information to other users associated with the email.

A computer program product for processing an email includes a computer readable storage medium having program code stored thereon. The program code is executable by a processor to perform a method. The method includes receiving, using the processor, operation status information of an operation on an email by a user. The operation status information includes user identification information of the user, email identification information of the email, and the current operation status on the email by the user. The method further includes storing, using the processor, the operation status information of the operation on the email by the user and transmitting, using the processor, the stored operation status information to other users associated with the email.

### BRIEF DESCRIPTION OF THE SEVERAL VIEWS OF THE DRAWINGS

Objects, features and advantages of the present disclosure will become more apparent through the more detailed description below of embodiments of the present disclosure with the accompanying drawings, wherein the same reference numerals generally refers to the same components.

FIG. 1 shows an exemplary computer system which is applicable to implement embodiments of the present invention.

FIG. 2 shows a flow chart of a method for processing an email according to an embodiment of the present invention.

FIG. 3 shows a flow chart of a method for processing an email according to another embodiment of the present invention.

FIG. 4 shows a flow chart of a method for processing an email according to still another embodiment of the present invention.

FIG. 5 shows an example of an inbox view in an email system client according to an embodiment of the present invention.

FIGS. 6(a) and 6(b) show a schematic diagram of a lookup table according to an embodiment of the present invention.

FIG. 7 shows a block diagram of a system for processing an email according to an embodiment of the present invention.

### DETAILED DESCRIPTION

The present invention relates to digital information processing, and more particularly, to a method and system for processing an email.

Some preferable embodiments will be described in more detail with reference to the accompanying drawings, in which preferable embodiments of the present disclosure have been illustrated. However, it is to be appreciated that the present disclosure can be implemented in various manners, and is not limited to the embodiments disclosed herein. On the contrary, those embodiments are provided for a thorough and complete understanding of the present disclosure, and for completely conveying the scope of the present disclosure to those skilled in the art.

The inventors of the present invention find that the root cause of the above problem is that, when people are processing an email, they do not know whether other people involved in the same email are also processing the email, and thus it is unavoidable to transmit/reply/read useless information or outdated information. With the size of emails becoming larger and larger, more and more storage space is required, and more and more time will be wasted on processing the emails.

However, current features of emails cannot reduce the time for writing emails, or avoid sending emails which are likely to be unnecessary. In order to avoid writing such emails, it would be beneficial to provide people with real-time information that other people are processing the same email, and thus an indication is given to people for selecting the best manner to process the email, so as to avoid unnecessary work.

According to an aspect of the present invention, there is provided a method for processing an email. The method includes: receiving operation status information of an operation on an email by a user, the operation status information including user identification information of the user, email identification information of the email and the current operation status on the email by the user; storing operation status information of the operation on the email by the user; and transmitting the stored operation status information to other users associated with the email.

According to another aspect of the present invention, there is provided a system for processing an email. The system includes: operation status receiving means configured to receive status information of an operation on an email by a user, the operation status information including user identification information of the user, email identification information of the email and the current operation status on the email by the user; operation status storing means configured to store operation status information of the operation on the email by the user; and operation status transmitting means configured to transmit the stored operation status information to other users associated with the email.

Using the present invention, other users can be notified of the operation being performed on the email by the user, to help the other users to determine whether they need to process, when to process or how to process the email, so as to help them to determine to reduce unnecessary work, thus improving the efficiency of email processing.

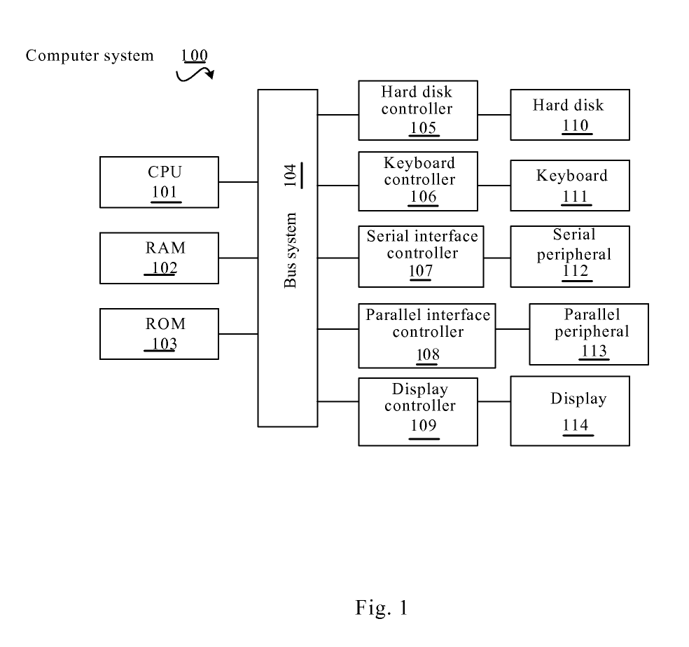

FIG. 1 shows an exemplary computer system 100 which is applicable to implement the embodiments of the present invention. As shown in FIG. 1, the computer system 100 may include: CPU (Central Process Unit) 101, RAM (Random Access Memory) 102, ROM (Read Only Memory) 103, System Bus (illustrated as “bus system”) 104, Hard Drive (disk) Controller 105, Keyboard Controller 106, Serial Interface Controller 107, Parallel Interface Controller 108, Display Controller 109, Hard Drive (disk) 110, Keyboard 111, Serial Peripheral Equipment 112, Parallel Peripheral Equipment 113 and Display 114. Among the above devices, CPU 101, RAM 102, ROM 103, Hard Drive Controller 105, Keyboard Controller 106, Serial Interface Controller 107, Parallel Interface Controller 108 and Display Controller 109 are coupled to the System Bus 104. Hard Drive 110 is coupled to Hard Drive Controller 105. Keyboard 111 is coupled to Keyboard Controller 106. Serial Peripheral Equipment 112 is coupled to Serial Interface Controller 107. Parallel Peripheral Equipment 113 is coupled to Parallel Interface Controller 108. And, Display 114 is coupled to Display Controller 109. It should be understood that the structure as shown in FIG. 1 is only for exemplary purposes rather than as a limitation of the present invention. In some cases, some devices may be added to or removed from the computer system 100 based on specific situations.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instruction means which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The method and system for processing an email according to the embodiments of the present invention will now be described with reference now to the Figures.

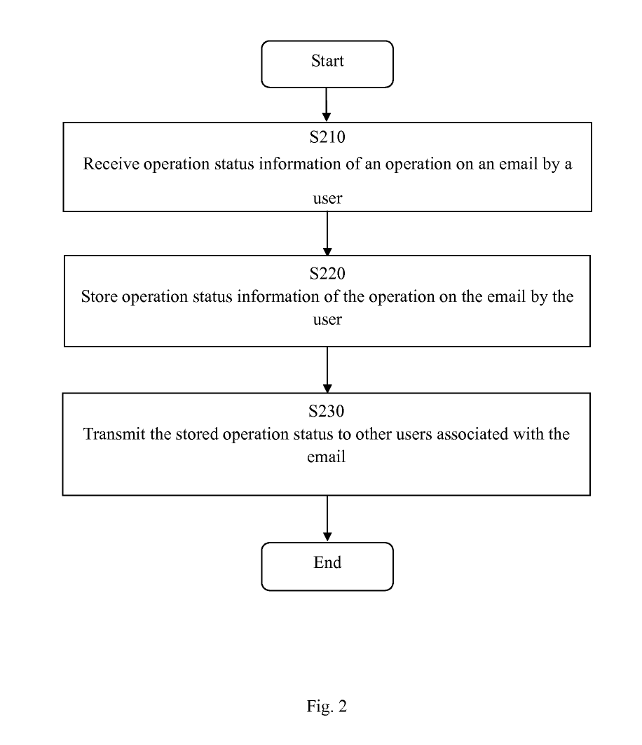

FIG. 2 shows a flow chart of the method for processing an email according to an embodiment of the present invention.

First, at step S210, information on operation status of the operation performed on an email by a user is received. According to an embodiment of the present invention, the operation status may be associated with the user identification information and email identification information of the email. The operation status information may include the user's identification information, email identification information of the email and the current operation status on the email by the user. Therein the user identification information uniquely identifies each user, and the email identification information is for uniquely identifying each email. The status of operation on the email by the user may be, e.g., opening the email, reading the email, writing the email and closing the email, etc.

At step S220, operation status information of the operation on the email by the user is stored, wherein the stored operation status is associated with the user identification information and email identification information. Therein, if this is the first time that the user performs an operation on the email, the operation status information on the email by the user will be directly stored. If operation status information on the email by the user has been previously stored, the status information will be stored after being updated.

At step S230, the stored operation status information is transmitted to other users associated with the email. The users associated with the email may include people on the To list, CC list, Blind CC list, and the sender sending the email. Here, the other users are people other than the user operating the email at step S210. For example, if the operation status received at step S210 is from a receiver on the To list of an email, then the other users may include the sender of the email, the other receivers on the To list, and the people on the CC or Blind CC list.

It can be seen from the specific embodiments to be described below that the step of sending the operation status information to other users may be performed after receiving the other users' request for refreshing the email system, or after the email system has searched out other users associated with the email, it may transmit the operation status information to the other users in real time.

For example, according to an embodiment of the present invention, after the operation status information of the operation on the email by the user is received, other users associated with the email may be searched for, for example, user identification information of other users associated with the email may be found out based on the email identification information; then, based on the user identification information of other users, the stored operation status information of the email by the user may be transmitted to these other users.

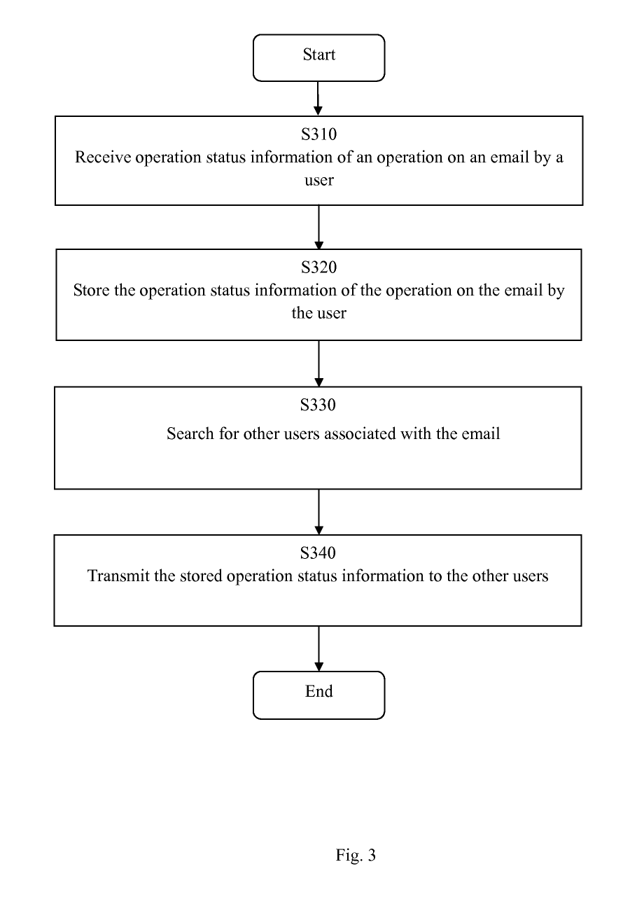

FIG. 3 shows a schematic view of a method for processing an email according to another embodiment of the present invention.

First, at step S310, operation status information of an operation on an email is received from a user.

At step S320, the operation status information of the operation on the email by the user is stored. The operation status may be stored in a lookup table together with the associated user identification information and the email identification information.

At step S330, other users associated with the email are searched for. For example, through the e-email identification information, a record containing the email identification information may be found in the lookup table, and the user information of other users involved in the record may be found, so that the other users associated with the email may be determined.

At step S340, the stored operation status information is transmitted to the determined other users.

According to another embodiment of the present invention, after the operation status of the operation performed on the email by the user is received, the update of the operation status is not immediately sent to other associated users, but is stored in the email server. When the email server receives a request to update the operation status of the email by other users, it sends the operation status information to the other users.

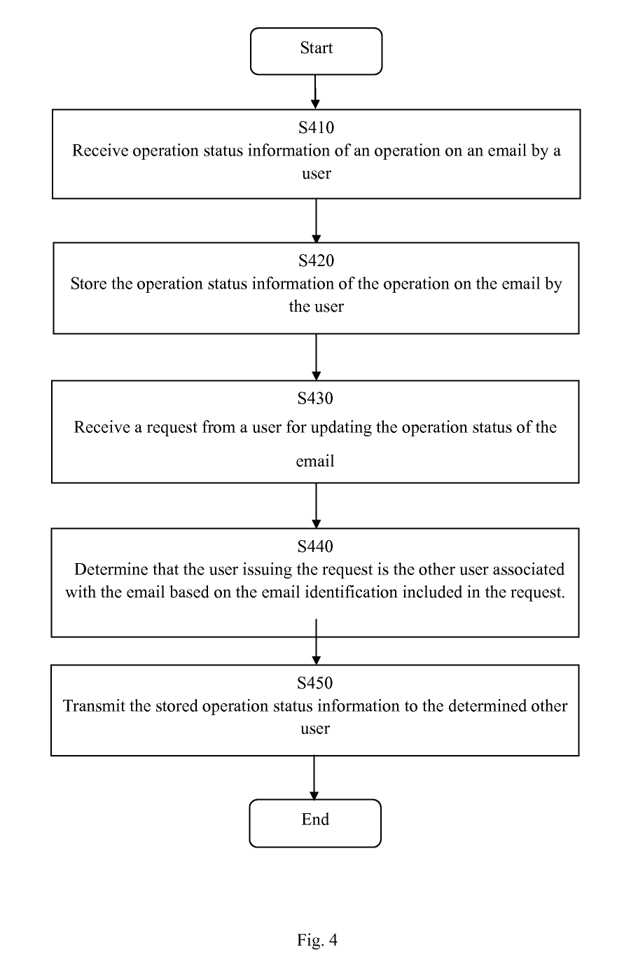

FIG. 4 shows a schematic view of a method for processing an email according to still another embodiment of the present invention. Therein, steps S410, S420 are the same as steps S310 and S320 in FIG. 3, and are not repeated here.

At step S430, a request from a user for updating the operation status of the email is received. For example, when a user refreshes the inbox or switches between the email view and the inbox view, a refresh request will be sent to the email server. When the refresh request is received, it may be deemed that the user's request for updating the operation status of the email is received. Alternatively, the user may separately send a specialized request requiring updating the operation status of the email to the email server.

At step S440, it is determined that the user issuing the request is the other user associated with the email based on the email identification included in the request.

At step S450, the stored operation status information is transmitted to the determined other user.

In this way, only when the other user issues the request, is the operation status information of the email sent to the other user. On one hand this may satisfy the requirement for notifying the operation status of the email to other users, and on the other hand, this can also reduce unnecessary communications between the server and clients. For example, if the user at that time does not want to be concerned with others' operations on an email, he/she does not need to receive at any time the operation status of the email by other users.

Thus, embodiments of the present invention may notify other users of the operation performed by the user on the email, so as to help the other users to determine whether they need to process, when to process or how to process the email. The present invention improves the efficiency of processing emails by notifying in real time the processing status of the email. It may help people to know what others are performing on the same email, thus helping to decide to reduce unnecessary work.

At the email client, some views can be provided to show people who is processing or has processed the current email (e.g., opening, reading, writing, transmitting, etc.). If someone is operating on the email, his status will be shown near the corresponding email (for example, someone is reading, someone is writing, how many people are reading, etc.). Moreover, updates of the status are in real time.

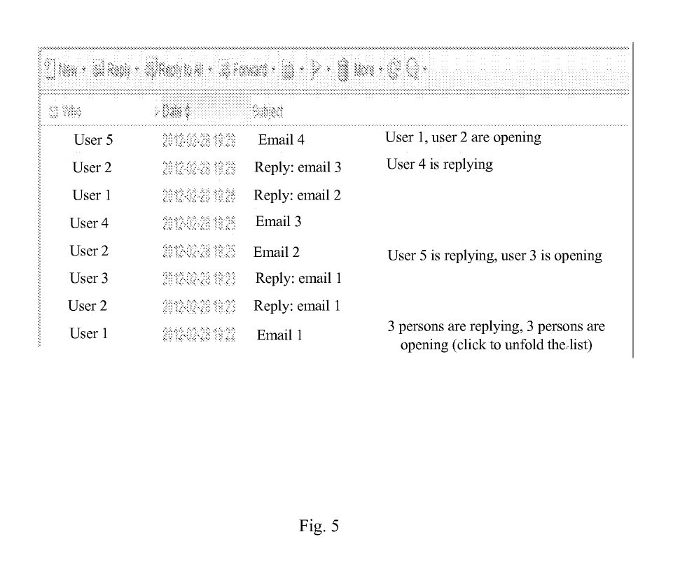

FIG. 5 shows an example of an inbox view at a client of an email system according to an embodiment of the present invention. For example, it can be seen from this view that the user can see that for email 4, user 1 and user 2 are opening email 4, user 5 is replying to email 2, user 3 is opening email 2, etc. Or, in the case of many people, as shown in the bottom part of FIG. 5, for email 1, 3 people are replying, 3 people are opening; and by clicking to unfold the list, it can be further known which users are performing the operation of replying or opening.

Therein, if a user opens and reads an email, the user's current operation status is reading the email. If the user opens an email, clicks any one of replying, replying to all or forwarding, and starts to write an email, the current operation status of the user is writing the email. If the user opens an email, and may read some of the contents therein, and then switch to another email, but does not close the previous email; at this time, the status of the previous email is “opening” for the current user, i.e., the operation status of opening the email. If the user clicks the button of closing the email, the use's current operation status is closing the email.

Although in the description of the present invention, we use four statuses of reading, writing, opening and closing as examples for illustrating, in actual applications, the designer of the email system may define different set of statuses.

According to an embodiment of the present invention, a status change push mechanism may be employed to provide each email processing status to everyone involved in the email. That is to say, each status change of a user on a specific email is notified to the others by the server.

According to another embodiment of the present invention, in actual applications, email users may select at their own discretion whether to receive other users' processing status of each email. In such a case, after the other user associated with the email is searched out, it may be further determined whether the other user desire to receive the operation status information of the email according to the user identification information of the other user; if the other user desires to receive, the stored operation status information on the email by the user is transmitted to the other user according to the user identification information of the other user; otherwise, it is not transmitted.

According an embodiment of the present invention, a lookup table may be maintained at the email server to record each operation performed on an email by a user. The table may include, e.g., the following information:
Record Identification (record ID), unique identification for identifying a record in the email server;
User Identification (user ID), identification of each email user;
Email Identification (email ID), identification of each email, with each email having only one email ID. If one email involves a plurality of users, all the users use the same email ID.
Current operation status: it may include but is not limited to the above four statuses: reading the email, writing the email, opening the email and closing the email.

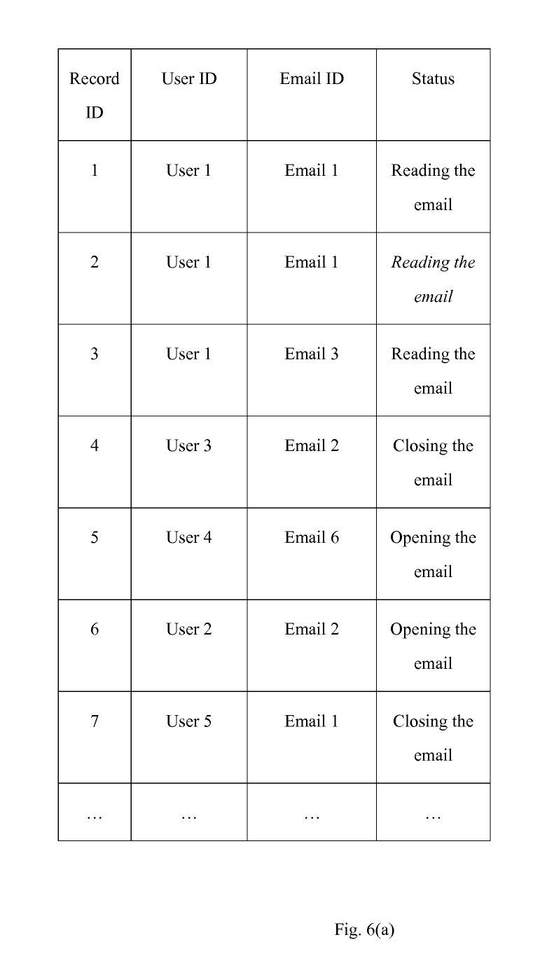

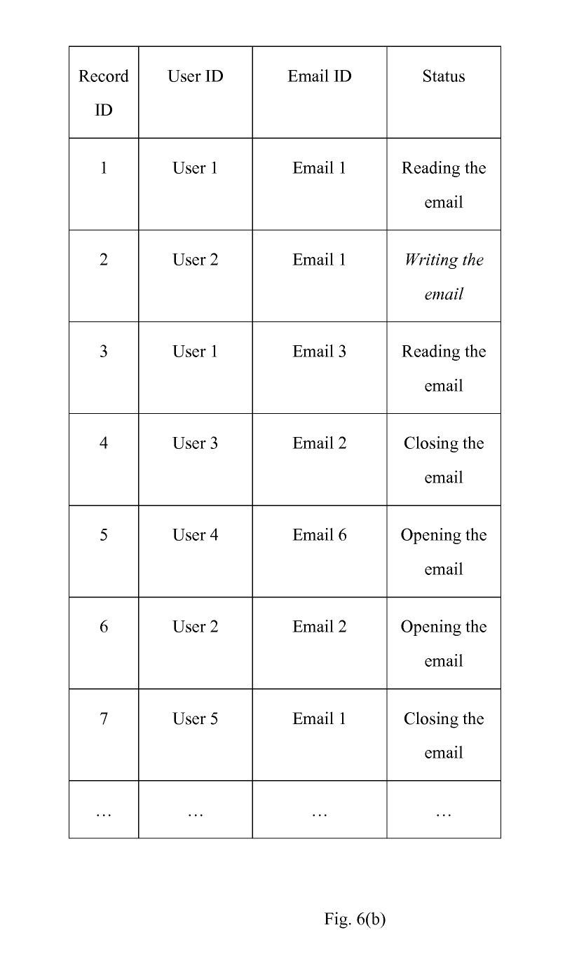

FIGS. 6(a), 6(b) show a schematic view of a table maintained by an email server, wherein each row in the table denotes a user's current activity on a specific email. Taking the schematic view shown in FIG. 6(a) as an example: user 1, user 2 and user 5 are on the email loop of email 1, user 1 and user 2 are reading the email, and user 5 has closed email 1; users 3 and 2 are on the email loop of email 2, user 3 has closed email 2, and user 2 has opened email 2; user 1 is on the email loop of email 3, and is reading the email; user 4 is on the email loop of email 6, and has just opened the email.

In the following will be described in detail the method according to an embodiment of the present invention by referring to the examples shown in the lookup table of FIGS. 6(a), 6(b), i.e., how the actions of user 2 (clicking reply and starting to write an email) will be reflected on the email clients of user 1 and user 5.

First, user 2 selects email 1 in his inbox, and clicks reply. At this time, the email client identifies that the email ID is email 1, and the status is “writing the email”.

The email client of user 2 sends information to the email server (user ID=user 2, email ID=mail 1, status=writing the email).

The email server obtains the information, and identifies that it is a status change request, and look up the table, finding ID=2 in the table from user ID (user 2) and email ID (email 1), and changes its status as writing the email, as shown in FIG. 6(b). Moreover, from email ID (email 1), it is found that two other users (user 1 and user 5) are also associated with the same email (email 1).

The email server pushes the following status information of user 2 to user 1 and user 5: user ID =user 2, email ID =email 1, status =writing the email.

The email clients of user 1 and user 5 obtain the push information, and display on their own interface user 2′ status: user 2 is writing the email.

By pushing status to the email server timely, status changes of each email may be sent to all the people involved in the email.

According to another embodiment of the present invention, after the user's operation status of the operation on the email is received, the update of the operation status may not be immediately transmitted to other associated users, but may be stored in the email server. Only when the email server receives the other user's request for updating the operation status of the email, does it send the operation status to the other user. In the following will be described in such an embodiment how user 2′ action (clicking reply and starting to write an email) will be reflected on the email client of user 5, wherein the previous steps are the same as the steps shown in the above embodiment.

First, user 2 selects email 1 in his inbox, and clicks reply. At this time, the email client identifies that the email ID is email 1, and the status is “writing the email”.

The email client of user 2 sends the information (user ID=user 2, email ID=email 1, status=writing the email) to the email server.

The email server obtains the information, identifies that it is a status change request, looks up in the table, finds ID=2 in the table from user ID (user 2) and email ID (email 1), and changes its status into writing the email, as shown in FIG. 6(b).

After that, user 5 sends a refresh request to the email server. For example, when user 5 refreshes the inbox or switches between the email view and the inbox view, a refresh request will be sent to the email server.

From email ID (email 1), it can be found that two other users are associated with the same email (user 1, user 2).

User 1 and user 2's operation statuses on email 1 are looked up in the lookup table, wherein user 1 is reading the email while user 2 is writing the email.

The email server transmits the status information of user 1 and user 2 to user 5: “user ID=user 2, email ID=email 1, status=writing the email”, “user ID=user 1, email ID=email 1, status=writing the email”.

User 5's email client obtains the status information, and shows on its interface the status of user 1 as user 1 is reading the email, and the status of user 2 as user 2 is writing the email.

By using the email operation status information, it is easy to learn that other people are processing the same email, and correspondingly select whether to keep working on this email or to switch to another email, or to deal with other matters than email, e.g., stop replying the email or even stop reading the email until receiving a further reply.

Users and companies using emails as cooperation tools can benefit from the present invention. For users, it can reduce the time for reading unnecessary or outdated information, reduce the time for writing unnecessary emails, and reduce the amount of emails in the inbox. Moreover, besides existing features, it may provide a new manner to sort emails by priority. For example, for a Notes system, the emails can be sorted according to the transmitter status indicators, receiver status indicators and message rules such as very import, ordinary, etc. For companies, on one hand, it may provide the productivity of cooperation, and on the other hand, it may reduce the space of the email server for storing these unnecessary emails and attachments.

The method of the present invention can be widely applied in various email systems, including client server system and network-based systems, commercial platforms or social networking platforms.

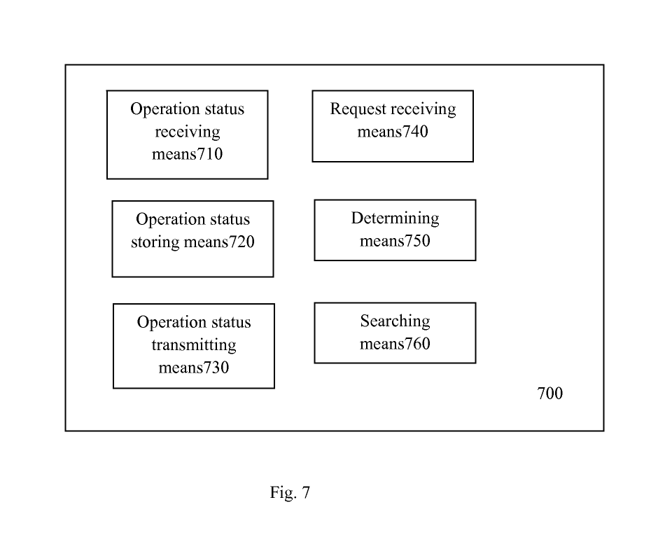

FIG. 7 shows a block diagram of system 800 for processing an email according to the present invention. System 700 may include operation status receiving apparatus 710, operation status storing means 720, operation status transmitting means 730.

According to an embodiment of the present invention, the operation status receiving means 710 is configured to receive operation status information of an operation performed on the email by a user, the operation status information includes user identification information of the user, email identification information of the email and the current operation status on the email by the user. The operation status storing means 720 is configured to store the operation status information of the operation performed on the email by the user. The operation status transmitting means 730 is configured to transmit the stored operation status information to other users associated with the email.

According to an embodiment of the present invention, the operation status transmitting means is configured to, in response to a request by the other user associated with the email, transmits the stored operation status information to the other user.

According to an embodiment of the present invention, system 700 further comprises request receiving means 740 configured to receive a request from a user for updating the operation status of the email; and determining means 750 configured to, based on the email identification information included in the request, determine that the user issuing the request is the other user associated with the email; wherein, the operation status transmitting means 730 is configured to transmit the stored operation status information to the determined other user.

According to an embodiment of the present invention, system 700 further comprise searching means 760 configured to search for other users associated with the email; wherein the operation status transmitting means 730 is configured to transmit the stored operation status information to the searched-out other users.

According to an embodiment of the present invention, the searching means 760 is configured to search for other users associated with the email based on the email identification information of the email.

According to an embodiment of the present invention, the operation status storing means 720 is configured to update the operation status information of the operation performed on the email by the user.

According to an embodiment of the present invention, the operation status storing means 720 is configured to store the operation status information of the operation on the email by the user in a lookup table.

The system of the present invention may be realized in an existing email server, e.g., it may be realized by employing a conventional email database used in all existing email systems and an extension to the email database, e.g., an email status database, wherein all the email information is managed by the email database. The email status database manages email processing statuses.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of processing an email, comprising:
receiving, using a processor, operation status information of an operation on an email by a user, the operation status information includes user identification information of the user, email identification information of the email, and the current operation status on the email by the user;
storing the operation status information of the operation on the email by the user; and
transmitting, using the processor, the stored operation status information to other users associated with the email.

2. The method of claim 1, wherein transmitting the stored operation status information to the other users associated with the email comprises, in response to a request by the other user associated with the email, transmitting the stored operation status information to the other user.

3. The method of claim 2, in response to requests by other users associated with the email, transmitting the stored operation status information to the other users comprises:
receiving a request from a user for updating operation status of the email;
based on the email identification information included in the request, determining that the user issuing the request is the other user associated with the email; and
transmitting the stored operation status information to the determined other user.

4. The method of claim 1, wherein transmitting the stored operation status information to the other user associated with the email comprises:
searching for other users associated with the email; and,
transmitting the stored operation status information to the searched-out other users.

5. The method of claim 4, wherein searching for other users associated with the email comprises:
searching for other users associated with the email based on the email identification information of the email.

6. The method of claim 1, wherein storing the operation status information of the operation on the email by the user further comprises:
updating the operation status information of the operation on the email by the user.

7. The method of claim 1, wherein the current operation status is selected from the group consisting of: opening the email, reading the email, writing the email, and closing the email.

8. The method of claim 1, wherein the other users associated with the email are selected from the group consisting of: at least one receiver on a To list of the email, at least one receiver on a CC list of the email, at least one receiver on a Blind CC list of the email, and the sender sending the email.

9. The method of claim 1, wherein storing the operation status information of the operation on the email by the user further comprises:
storing the operation status information of the operation on the email by the user in a lookup table.

10. A system for processing an email, comprising:
a processor programmed to initiate executable operations comprising:
receiving operation status information of an operation on an email by a user, the operation status information includes user identification information of the user, email identification information of the email, and the current operation status on the email by the user;
storing the operation status information of the operation on the email by the user; and
transmitting the stored operation status information to other users associated with the email.

11. The system of claim 10, wherein transmitting the stored operation status information to the other users associated with the email comprises, in response to a request by the other user associated with the email, transmitting the stored operation status information to the other user.

12. The system of claim 11, in response to requests by other users associated with the email, transmitting the stored operation status information to the other users comprises:
receiving a request from a user for updating operation status of the email;
based on the email identification information included in the request, determining that the user issuing the request is the other user associated with the email; and
transmitting the stored operation status information to the determined other user.

13. The system of claim 10, wherein transmitting the stored operation status information to the other user associated with the email comprises:
searching for other users associated with the email; and, transmitting the stored operation status information to the searched-out other users.

14. The system of claim 13, wherein searching for other users associated with the email comprises:
searching for other users associated with the email based on the email identification information of the email.

15. The system of claim 10, wherein storing the operation status information of the operation on the email by the user further comprises:
updating the operation status information of the operation on the email by the user.

16. The system of claim 10, wherein the current operation status is selected from the group consisting of: opening the email, reading the email, writing the email, and closing the email.

17. The system of claim 10, wherein the other users associated with the email are selected from the group consisting of: at least one receiver on a To list of the email, at least one receiver on a CC list of the email, at least one receiver on a Blind CC list of the email, and the sender sending the email.

18. The system of claim 10, wherein storing the operation status information of the operation on the email by the user further comprises:
storing the operation status information of the operation on the email by the user in a lookup table.

19. A computer program product for processing an email, the computer program product comprising a computer readable storage medium having program code stored thereon, the program code executable by a processor to perform a method comprising:
receiving, using the processor, operation status information of an operation on an email by a user, the operation status information includes user identification information of the user, email identification information of the email, and the current operation status on the email by the user;
storing, using the processor, the operation status information of the operation on the email by the user; and
transmitting, using the processor, the stored operation status information to other users associated with the email.

20. The computer program product of claim 19, wherein transmitting the stored operation status information to the other users associated with the email comprises, in response to a request by the other user associated with the email, transmitting the stored operation status information to the other user.
